(19) United States
(12) Patent Application Publication
(10) Pub. No.: US 2014/0358415 A1
(43) Pub. Date: Dec. 4, 2014

(54) FLIGHT PREDICTION SYSTEM

(71) Applicant: Airservices Australia, Canberra (AU)

(72) Inventors: Gregory Neil McDonald, Brunswick West (AU); Jesper Bronsvoort, Kensington (AU)

(73) Assignee: Airservices Australia, Canberra (AU)

(21) Appl. No.: 14/298,387

(22) Filed: Jun. 6, 2014

Related U.S. Application Data
(63) Continuation of application No. PCT/AU2012/001485, filed on Dec. 6, 2012.

(30) Foreign Application Priority Data
Dec. 6, 2011 (AU) 2011905074

(51) Int. Cl. G08G 5/00

(52) U.S. Cl. CPC G08G 5/0082; G08G 5/003
USPC 701/120

(57) ABSTRACT

A method of predicting the trajectory of an aircraft is disclosed in this specification. The method involves predicting corrective adjustments that an aircraft flight management system is expected to make to follow a reference trajectory. A ground based system receives a reference trajectory that the aircraft flight management system intends to fly and predicts an actual trajectory using the predicted corrective adjustments. The actual trajectory predicted by the system differs from the reference trajectory in a free dimension that is not restrained in the reference trajectory.

### TECHNICAL FIELD

The present invention relates to a system and method for predicting flight characteristics of an aircraft, and particularly, although not exclusively, to a system and method for predicting the trajectory of an aircraft for air traffic control.

### BACKGROUND

As the number of commercial flights increases, congestion at major airports becomes a significant issue for the aviation industry. One way to manage congestion around an airport is for air traffic controllers and operators to properly plan the air traffic around an airport. The planning must be implemented to ensure aircrafts are processed as efficiently as possible whilst ensuring safety, and noise abatement regulations are followed.

For air traffic control and aircraft to operate efficiently, it is desirable for the air traffic controller to understand the intention of each aircraft due to enter the airspace controlled and managed by the controller. In these situations, pilots file a flight plan or may announce through the radio by voice of their position, aircraft type and intention, in which case an air traffic controller may interpret this intention with relevant air traffic information so that together, the pilot and the controller may plan and direct the aircraft to its desired path. In more advanced systems, a flight management computer on board an aircraft may process a pilot's command and produce a planned trajectory for the aircraft to follow. These planned trajectories may then be sent from the computer aboard the aircraft to air traffic control to state a planned trajectory of the aircraft. On board the aircraft the planned trajectory is used as reference trajectory for the pilot or autopilot to control to.

Whilst this planned trajectory information relating to the aircraft is helpful to air traffic control in planning an aircraft's arrival, the actual trajectory of the aircraft is usually different from the planned trajectory, due, for example, to the aircraft experiencing conditions which were not taken into account in calculation of the planned trajectory. Deviations from the planned trajectory reduce predictability for air traffic control even if this planned trajectory is known to air traffic control.

### SUMMARY OF THE INVENTION

In accordance with a first aspect, the present invention provides a method of predicting an actual trajectory of an aircraft, comprising the steps of receiving a reference trajectory expected to be followed by the aircraft, and applying a process to determine a deviation from the reference trajectory to provide a predicted actual trajectory.

In an embodiment, the reference trajectory is a planned trajectory planned for the aircraft. In an embodiment, the planned trajectory may be calculated by a flight management system (FMS) of an aircraft.

In an embodiment, the process that is applied is a process of simulating the planned trajectory with the application of one or more other models to the planned trajectory. The one or more other models may include an environmental model and/or an Aircraft Performance Model. Such models may have been applied in determining the planned trajectory. The models provided for predicting the actual trajectory will be generally different from the models applied in determining the planned trajectory, and may have available to them more accurate components, such as better environmental data, for example.

Commonly, reference trajectories planned by the FMS of an aircraft are considered to be “best practice” from the aircraft's point of view. Ideally, these reference trajectories should be facilitated by air traffic control with minimised amendment. Even if air traffic control can facilitate the reference trajectory, because the calculated reference trajectories are not perfect and will be deviated from, this leads to reduced predictability to air traffic control and subsequent inefficiencies to aircraft operation. Advantageously, in at least an embodiment, the step of reprocessing the reference trajectory to determine deviations from the reference trajectory provides a more accurate prediction of actual trajectories of aircraft. Consequently, air traffic can be managed with improved efficiency.

In an embodiment, the process is arranged to calculate deviations in aircraft possessed energy from the aircraft possessed energy reflected by the reference trajectory.

In an embodiment, the method may be applied to a plurality of aircraft to give a better prediction of actual trajectories for the plurality of aircraft. Advantageously, in embodiments, this enables air traffic control to have a more accurate picture of the air space and future positions of aircraft, and hence can provide more efficient services to the individual aircraft.

In an embodiment, the process comprises the steps of deriving a set of corrected adjustments expected to be executed by the aircraft in following the reference trajectory. In an embodiment, the set of corrective adjustments includes at least one control directive arranged to direct the aircraft to follow the reference trajectory in at least one dimension or variable. The control directive may be arranged to alter the actual trajectory of the aircraft by directing the aircraft to correct one or more deviations from the reference trajectory.

In an embodiment, the step of predicting the actual trajectory comprises the step of processing the reference trajectory with the set of corrective adjustments to result in a prediction of an actual trajectory.

In an embodiment, the one or more expected deviations from the planned trajectory are determined by modelling the performance of the aircraft in following the planned trajectory.

In an embodiment, the one or more expected deviations from the planned trajectory are determined by adaptive system learning through modelling the average performance of multiple preceding aircraft in following their respective planned trajectory.

In an embodiment, the step of modelling the performance of the aircraft in following the planned trajectory includes the application of environmental models to at least one characteristic of the aircraft to derive the expected deviations of the planned trajectory by the aircraft.

In an embodiment, the at least one characteristic of the aircraft is modelled by an aircraft performance model associated with the aircraft.

In an embodiment, the at least one characteristic includes an expected mass of the aircraft in following the planned trajectory.

In an embodiment, the at least one characteristic further includes an expected speed of the aircraft in following the planned trajectory.

In an embodiment, the reference trajectory is received from an aircraft flight management system.

In an embodiment, the reference trajectory is received from a ground based system arranged to predict the aircraft planned trajectory. In an embodiment, the ground based system is arranged to simulate the aircraft FMS.

In accordance with a second aspect, the present invention provides a system for predicting an actual trajectory of an aircraft, comprising:

a processor arranged to determine a deviation from the reference trajectory of an aircraft and to utilise the deviation to provide a predicted actual trajectory of the aircraft.

In an embodiment, the reference trajectory is a planned trajectory of the aircraft. In an embodiment, the planned trajectory is calculated by a flight management system of the aircraft. In an alternative embodiment, the planned trajectory may be calculated by a ground based system, which may be arranged to simulate an FMS of an aircraft.

In an embodiment, the processor comprises an adjustment processor arranged to derive a set of corrective adjustments expected to be executed by the aircraft in following the reference trajectory. In an embodiment, the set of corrective adjustments includes at least one control directive arranged to direct the aircraft to follow the planned trajectory in at least one dimension or variable. In an embodiment, the processor further comprises a function arranged to process the reference trajectory with the set of corrective adjustments to provide the predicted actual trajectory.

In accordance with a third aspect, the present invention provides a method for predicting an actual trajectory of an aircraft comprising the steps of:

receiving a reference trajectory of an aircraft;

deriving a set of corrective adjustments expected to be executed by the aircraft in following the reference trajectory, wherein the set of corrective adjustments includes at least one control directive arranged to direct the aircraft to follow the reference trajectory; and

processing the reference trajectory with the set of corrective adjustments to predict an actual trajectory to be flown.

In accordance with a fourth aspect, the present invention provides a system for predicting an actual trajectory of an aircraft, comprising:

a gateway arranged to receive a reference trajectory of an aircraft;

an adjustment processor arranged to derive a set of corrective adjustments expected to be executed by the aircraft in following the reference trajectory, wherein the set of corrective adjustments includes at least one control directive arranged to direct the aircraft to follow the reference trajectory; and

a function arranged to process the planned trajectory with the set of corrective adjustments to predict an actual trajectory to be flown.

In accordance with a fifth aspect, the present invention provides a system for predicting an actual trajectory of an aircraft, comprising:

a processor arranged to receive a reference trajectory expected to be followed by the aircraft, and to apply a process to determine a deviation from the reference trajectory to provide a predicted actual trajectory for the aircraft.

In accordance with a sixth aspect, the present invention provides a method of predicting an actual trajectory of an aircraft, comprising the steps of:

receiving a reference trajectory planned by a flight management system associated with the aircraft,

applying a process to predict corrective adjustments that the aircraft flight management system is expected to make to follow the reference trajectory in one or more controlled dimensions, and

predicting an actual trajectory from the predicted corrective adjustments, the actual trajectory differing from the reference trajectory in a free dimension.

In an embodiment, the method comprises generating an updated time of arrival for the aircraft at a target destination from the actual trajectory predicted for the aircraft.

In an embodiment, the process is arranged to calculate deviations in aircraft possessed energy from the aircraft possessed energy reflected by the reference trajectory.

In an embodiment, the process comprises the steps of deriving a set of corrective adjustments expected to be executed by the aircraft in following the reference trajectory.

In an embodiment, the set of corrective adjustments includes at least one control directive arranged to direct the aircraft to follow the reference trajectory in at least one controlled dimension or variable.

In an embodiment, the step of predicting the actual trajectory comprises the step of processing the reference trajectory with the set of corrective adjustments, to result in a prediction of an actual trajectory.

In an embodiment, the one or more deviations from the reference trajectory are determined by modelling the performance of the aircraft in following the reference trajectory.

In an embodiment, the step of predicting the actual trajectory comprises processing the reference trajectory with a set of corrective adjustments determined by adaptive system learning through modelling average performance of a plurality of preceding aircraft in following respective planned trajectories.

In an embodiment, the step of modelling the performance of the aircraft in following the planned trajectory includes the application of environmental models to at least one characteristic of the aircraft to derive the expected deviations of the reference trajectory by the aircraft.

In an embodiment, the environmental model consists of air pressure, air temperature, wind speed and wind direction parameters at a plurality of altitudes within a localised region adjacent to the reference trajectory.

In an embodiment, the environmental model is updated by parameters received from a destination weather station, surrounding aircraft or another source of real-time weather observations.

In an embodiment, the method comprises inferring at least one characteristic of the aircraft from the received reference trajectory of an aircraft.

In an embodiment, at least one characteristic of the aircraft is modelled by an aircraft performance model associated with the aircraft.

In an embodiment, the at least one characteristic includes an expected mass of the aircraft in following the reference trajectory.

In an embodiment, the at least one characteristic further includes an expected speed of the aircraft in following the reference trajectory.

In an embodiment, the step of inferring the expected mass and expected speed of the aircraft in following the reference trajectory from trajectory data from the aircraft Future Air Navigation Systems (FANS) Intermediate Projected Intent (IPI).

In accordance with a seventh aspect, the present invention provides a flight prediction method comprising:

receiving a reference trajectory from an aircraft flight management system, the reference trajectory defining a planned descent path for the aircraft,

generating an environmental profile for a target destination from localised environmental parameters derived from measurements at the target destination,

predicting deviations of the aircraft from the reference trajectory using the localised environmental profile for the target destination and characteristics of the aircraft, and

determining a descent plan for the aircraft from the reference trajectory and the predicted deviations of the aircraft from the reference trajectory.

In an embodiment, the method comprises generating an updated time of arrival for the aircraft at the target destination from the predicted deviations of the aircraft from the reference trajectory.

In an embodiment, the method comprises predicting corrective adjustments that the aircraft flight management system is expected to make during descent to compensate for the predicted deviations from the reference trajectory.

In an embodiment, the method comprises determining a corrected decent trajectory for the aircraft by applying the determined corrective adjustments to the reference trajectory received from the aircraft's flight management system.

In an embodiment, the method comprises receiving localised environmental parameters from a destination weather module, the environmental parameters including air pressure, wind strength and wind direction at the target destination.

In an embodiment, the method comprises applying the received air pressure, wind strength and wind direction parameters at a plurality of altitudes within a localised region adjacent the destination to construct the environmental profile.

In an embodiment, the method comprises receiving aircraft characteristics from an aircraft flight management system, the aircraft characteristics including current mass and current speed.

In an embodiment, the method comprises projecting aircraft intent from the reference trajectory of an aircraft and inferring characteristics of the aircraft from the projected aircraft intent.

In an embodiment, the method comprises projecting aircraft intent at a plurality of discrete change points defined by the reference trajectory for an aircraft and inferring the mass and speed of the aircraft at each of the change points.

In accordance with an eighth aspect, the present invention provides a flight prediction system comprising:

an aircraft interface that communicates with a plurality of aircraft to receive reference trajectories determined by aircraft flight management systems, the reference trajectories defining a planned descent path for a corresponding aircraft,

a weather module that generates an environmental profile for a target destination from localised environmental parameters derived from measurements at the target destination,

a forecasting module that predicts aircraft deviations from a reference trajectory using the localised environmental profile for a target destination and characteristics of a corresponding aircraft, and

an air traffic module that determines a descent plan for an aircraft from a corresponding reference trajectory and the predicted deviations of the aircraft from the reference trajectory.

In an embodiment, the system comprises a scheduler that calculates updated arrival times for aircraft at a target destination from predicted deviations of the aircraft from a reference trajectory, the scheduler being integrated with the air traffic module.

In an embodiment, the system comprises a flight path module that predicts corrective adjustments that the aircraft flight management system is expected to make during descent to compensate for predicted aircraft deviations from the reference trajectory.

In an embodiment, the system comprises a flight plan module that determines a corrected decent trajectory for an aircraft by applying the corrective adjustments determined for the aircraft to a reference trajectory received from the aircraft's flight management system.

In an embodiment, the system comprises a weather interface that receives localised environmental parameters from a destination weather module, the environmental parameters including air pressure, air temperature, wind strength and wind direction at the destination.

In an embodiment, the system comprises a climate module that applies the received air pressure, air temperature, wind speed and wind direction parameters at a plurality of altitudes within a localised region adjacent the destination to construct an environmental profile, the climate module being integrated with the weather module.

In an embodiment, the system comprises an inference module that projects aircraft intent from a corresponding reference trajectory and infers aircraft characteristics from the projected aircraft intent.

In an embodiment, the system comprises an inference module that projects aircraft intent at a plurality of discrete change points defined by the reference trajectory for an aircraft and infers the mass and speed of the aircraft at each of the change points.

In accordance with a ninth aspect, the present invention provides a computer program comprising instructions for controlling a computer to implement a method in accordance with the first or third or sixth aspects of the present invention.

In accordance with a tenth aspect, the present invention provides a computer readable medium, providing a computer program in accordance with the ninth aspect of the present invention.

In accordance with an eleventh aspect, the present invention provides a data signal, comprising a computer program in accordance with the ninth aspect of the present invention.

### BRIEF DESCRIPTION OF THE DRAWINGS

Embodiments of the present invention will now be described, by way of example only, with reference to the accompanying drawings, in which:

FIG. 1 is a chart illustrating an example profile of an aircraft performing a planned descent to a destination airport;

FIG. 2 is a chart illustrating a possible procedure followed by a flight management system in planning a descent trajectory of the aircraft shown in FIG. 1;

FIG. 3 is a chart illustrating an aircraft about to execute a planned descent trajectory;

FIG. 4 is a chart illustrating the aircraft in FIG. 3 and deviating from the planned descent trajectory;

FIG. 5 is a block diagram of a system in accordance with an embodiment of the present invention, for predicting an actual trajectory of an aircraft;

FIG. 6 is a flow diagram illustrating a data flow process of the system of FIG. 5;

FIG. 7 is a bar chart comparing the energy determined by an example flight management system and the system of FIG. 5 with the actual energy to be dissipated on descent by an aircraft;

FIG. 8 is a diagram illustrating an overview of a process in accordance with an embodiment of the present invention;

FIG. 9 is a chart illustrating deviations from a reference trajectory in the vertical plane, for an aircraft;

FIG. 10 is a vertical profile of Intermediate Projected Intent (IPI) for an aircraft for illustration of calculation of descent target CAS and mass on descent in accordance with one embodiment of the present invention.

### DETAILED DESCRIPTION OF THE PREFERRED EMBODIMENT

Modern commercial jets are sophisticated aircraft, which include complex computing and communication systems. In modern commercial aircraft (or other modern aircraft) such as the Boeing 7X7 or the Airbus A3XX, the systems may include flight management system (FMS). The FMS will generally include a Flight Management Computer (FMC), a Command and Display Unit (CDU) and Flight Data Storage Units (FDSU). The FMS is a computer system arranged to automate a wide variety of in-flight tasks such as flight plan management. Depending on the complexity of the FMS, the FMS can be programmed by pilots to provide reference signals to an Automatic Flight Control System (AFCS) and thus allowing the FMS to guide the aircraft along a specific flight plan or to automate a variety of tasks such as, but not limited to, flight optimisation, navigation, flight guidance or to execute a planned descent to a destination airport.

When an aircraft is making its descent to a destination airport, the air traffic control around the airport must manage and control the air traffic that is around the airport so that aircraft can safely descend, approach and land at the destination airport. As such the air space around an airport is a valuable resource and it must be carefully managed. Pilots and operators of aircraft preparing to perform a descent to an airport prefer to find an “optimised descent path” which uses minimal resources, such as fuel and time, whilst allowing the aircraft to follow a desired path within a desired time window to land the aircraft with the minimal resource usage and delay. Thus when an aircraft is due to land at a specific airport, the pilot may, with information or guidance from ground based air traffic control, program the FMS to make an optimal descent profile into the destination airport.

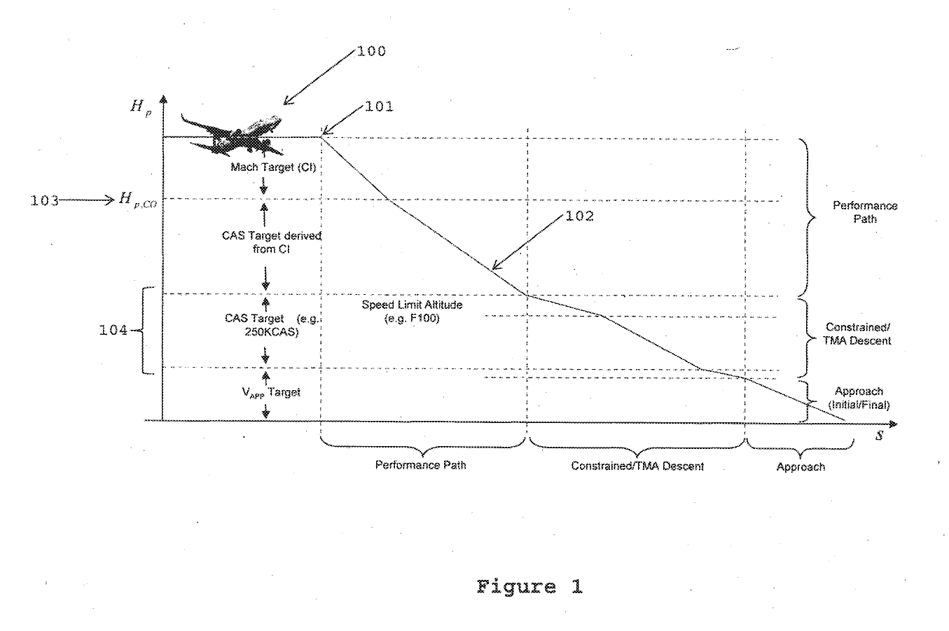

With reference to FIG. 1, there is illustrated a diagram showing an altitude profile of an aircraft 100 performing an example of an optimised procedural descent 102. In this example, the pilots have already programmed the FMS to perform a descent to a destination airport for which the reference or planned trajectory is illustrated by 102. Upon reached the planned descent point 101, the FMS commands the throttle controls of the aircraft to change the throttle setting of the aircraft to idle and to initiate the aircraft's descent at the cruise Mach number (cruise speed forward propagation). At crossover altitude H_{p,CO} 103, the descent is continued at the target descent calibrated airspeed (CAS) until a first constraint. Generally there exists some speed constraint within the terminal manoeuvring area (TMA) or below a certain flight level. In one example, Australian airspace specifically requires that the airspeed of an aircraft below 10,000 ft to be constrained to 250KCAS (250 below 10). This results in deceleration being achieved by a (near) level segment 104 at idle thrust (deceleration on profile). The descent continues at 250KCAS until at some stage, depending on operator procedures, further deceleration to minimum clean speed is initiated. From this point on the aircraft is decelerated on profile to final approach speed and the high lift devices (flaps or spoilers) are configured accordingly in steps. At final approach, thrust may be required to maintain airspeed and stabilise the aircraft for landing.

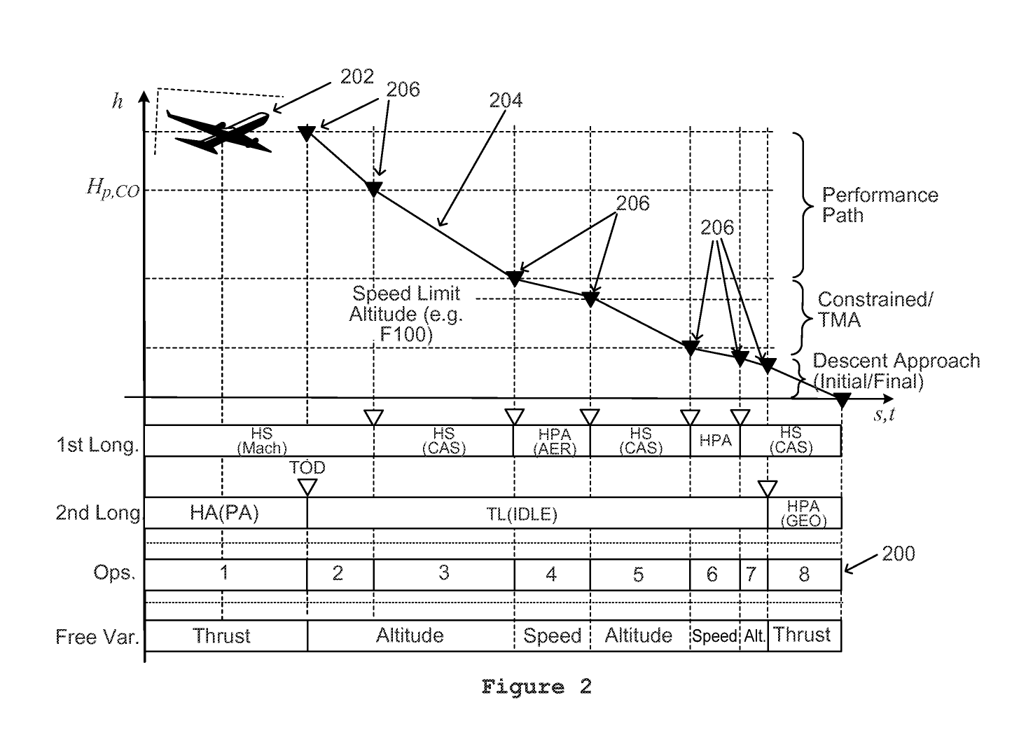

To be able to perform the descent as described above, the FMS, once programmed by the pilots to initiate the descent, will need to calculate the optimal descent path when the aircraft is still in cruise. In one example, the descent may be calculated in reverse from the destination runway threshold and by assuming an “optimal aircraft intent”. Aircraft intent can be described as an unambiguous description of how the aircraft intends to meet the objectives and constraints specified by the flight intent (the objectives of the aircraft operator and the constraints from the aircraft characteristics, airspace resources and safety requirements). In the preceding paragraphs, a basic description of this aircraft intent is expressed in words. With reference to FIG. 2, there is illustrated an example of a set of logic steps 200 (1 to 8), operating in reverse (starting with 8 and ending with the final step 1) which allows the FMS to calculate an optimal descent path for the aircraft 202. Explanation of each of the steps (1 to 8) is listed below in Table 1. The terminology used in Table 1 is taken from the Aircraft Intent Description Language (Javier Lopez-Leones et al., “The Aircraft Intent Description Language: A key enabler for air-ground synchronization in Trajectory-Based Operations”, Digital Avionics System Conference, 2007).

TABLE 1

| | Instruction | Instruction | Trigger | Free | |
|---|---|---|---|---|---|
| | 1st Long. | 2nd Long. | Condi- | Vari- | |
| Ops | Thread | Thread | tion | able | Description |
| 8 | Hold | Hold | Final | Thrust | Final Approach. A |
| | Speed | Path | Approach | | fixed geometric |
| | (CAS) | Angle | Altitude | | path angle is flown |
| | | (Geo- | | | from the final |
| | | metric) | | | approach altitude |
| | | | | | down to the runway |
| | | | | | threshold (e.g. −3 |
| | | | | | degrees for a |
| | | | | | standard ILS). |
| 7 | Hold | Throttle | Initial | Altitude | An idle segment |
| | Speed | Law | Approach | | assuming the |
| | (CAS) | (IDLE) | Attitude | | initial approach |
| | | | | | speed is held. This |
| | | | | | speed is the |
| | | | | | minimum clean |
| | | | | | configuration |
| | | | | | speed. |
| 6 | Hold | Throttle | 250KCAS | Speed | Slow down to |
| | Path | Law | | | minimum clean |
| | Angle | (IDLE) | | | configuration |
| | (Aero- | | | | speed. Depending |
| | dynamic) | | | | on aircraft type and |
| | | | | | FMS, the |
| | | | | | aerodynamic path is |
| | | | | | about −1 ≦ γ_{TAS} ≦ |
| | | | | | 0 degrees. As this |
| | | | | | path is too shallow |
| | | | | | to maintain a |
| | | | | | constant speed at |
| | | | | | idle thrust, the |
| | | | | | aircraft slows |
| | | | | | down. Some aircraft |
| | | | | | use a descent rate |
| | | | | | of 500 fpm for the |
| | | | | | slow down segment. |
| 5 | Hold | Throttle | Speed | Altitude | Idle segment at |
| | Speed | Law | Limit | | 250KCAS. |
| | (CAS) | (IDLE) | Altitude | | |
| | | | F100 | | |
| 4 | Hold | Throttle | CI | Speed | Slow down to |
| | Path | Law | descent | | 250KCAS. Depend- |
| | Angle | (IDLE) | CAS | | ing on aircraft type |
| | (Aero- | | | | and FMS, the |
| | dynamic) | | | | aerodynamic path is |
| | | | | | about −1 degree. |
| 3 | Hold | Throttle | Cross- | Altitude | Idle segment at CI |
| | Speed | Law | over | | determined CAS |
| | (CAS) | (IDLE) | altitude | | (280KCAS standard |
| | | | | | in Australia). |
| 2 | Hold | Throttle | Cruise | Altitude | Idle segment at CI |
| | Speed | Law | Altitude | | determined Mach |
| | (Mach) | (IDLE) | (Top of | | number. |
| | | | Descent) | | |
| 1 | Hold | Hold | N/A | Thrust | Cruise segment at |
| | Speed | Altitude | | | Cost Iindex (CI) |
| | (Mach) | (Pressure | | | determined Mach |
| | | Altitude) | | | number. |

Once the FMS performs each of these steps, the FMS is able to provide a resulting computed trajectory 204. This trajectory can also be called a planned or reference trajectory in that the FMS has now calculated a trajectory planned for execution by the aircraft as it executes the descent into the destination airport.

The planned trajectory 204 can be sampled at each trajectory change points, \vec{x}ᵢ corresponding to the end of each operation 206. This therefore allows the calculation of a 3D geometric descent path (GDP). One embodiment of geometric descent path is described by equations (1) and (2). There are other

X̅_{GDP}={\vec{x}₁,\vec{x}₂, . . . ,\vec{x}ₙ} (1)

In which case, the planned descent point, which is the top of descent (TOD) is given by equation (2),

\vec{x}_{TOD}=\vec{x}₁ (2)

Once these variables are computed by the FMS, the planned path remains relatively constant in open loop (no time of arrival control performed by FMS) in the presence of forecast weather or wind errors (provided these errors remain within limits).

In one example, an objective of a FMS performing the planning phase to determine an optimised descent is to find the descent profile for which the required deceleration and altitude loss from cruise conditions are achieved ideally by the work done by drag forces and gravity, i.e. the engine throttle is set to idle and kept there until the Final Approach Fix (FAF). In one example, one method in which this can be performed is by accurate estimation of the total energy of the aircraft on descent, which may be performed implicitly by the FMS. The following equation (3) provides a simplified expression for the energy balance between TOD and the FAF,

$$\frac{1}{2} m {V}_{TOD}^{2} + {mgh}_{TOD} = \frac{1}{2} m {V}_{FAF}^{2} + {mgh}_{FAF} + {\int }^{PATH} \hat{T} d s - {\int }^{PATH} \hat{D} d s + {E}_{EXC} \qquad ( 3 )$$

The left hand terms indicate the total energy possessed by the aircraft at TOD. This total energy is to be reduced such that the final approach speed and altitude are reached at the FAF. The total energy to be dissipated on descent implicitly determined in the descent planning process is therefore given by (equation 4).

$${\hat{E}}_{DES} = \frac{1}{2} m {V}_{FAF}^{2} + {mgh}_{FAF} + {\int }^{PATH} \hat{T} d s - {\int }^{PATH} \hat{D} d s \qquad ( 4 )$$

In addition to an accurate prediction of the aerodynamic and gravity forces involved, an accurate prediction of the expected wind and temperature on descent is required. However, the weather forecast model used by the FMS is rather basic. This is because information provided to an aircraft, even by a data link, is relatively primitive in terms of detailed data which are available to ground based air traffic control systems. As such, the accuracy of the (implicitly) predicted total energy to be dissipated on descent is adversely affected. This would result in that there will be difference between the predicted energy to be dissipated and actual energy to be dissipated on descent, E_{EXC} (excess energy, which is negative in case of a shortage). This difference in the energies would therefore lead to deviations from the planned trajectory when the aircraft is executing the planned trajectory.

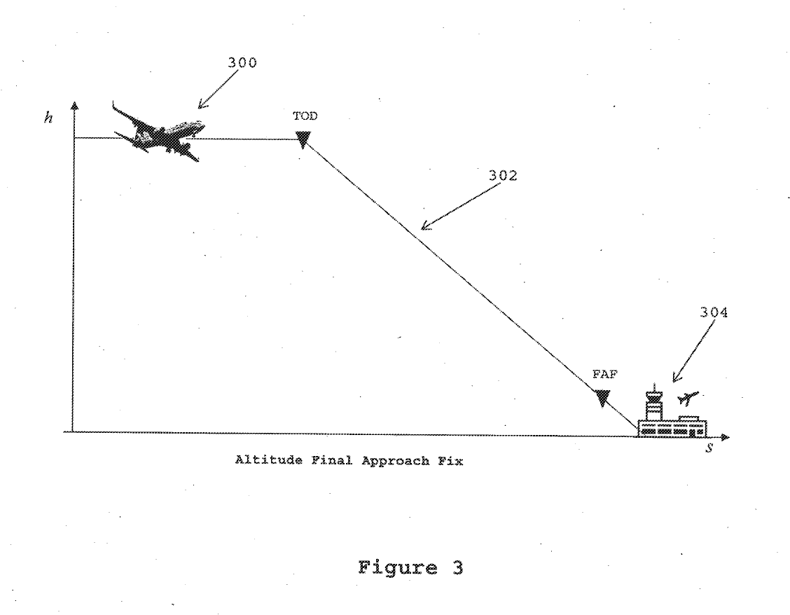

As an example in illustrating the differences between the estimated energy on descent and the actual energy on descent, FIG. 3 illustrates the altitude profile of an aircraft 300 planning a descent trajectory. In this example, the pilots of the aircraft have entered instructions to the FMS to prepare a planned descent trajectory as described in a previous paragraph. After the FMS has determined a planned trajectory 302 upon instructions from the pilots to land the aircraft 300 at a destination airport 304 and the aircraft has reached the planned descent point, the FMS will command the throttle to idle and command a pitch down provided the vertical path guidance is engaged and an altitude lower than the current cruise altitude is selected on the Mode Control Panel (MCP).

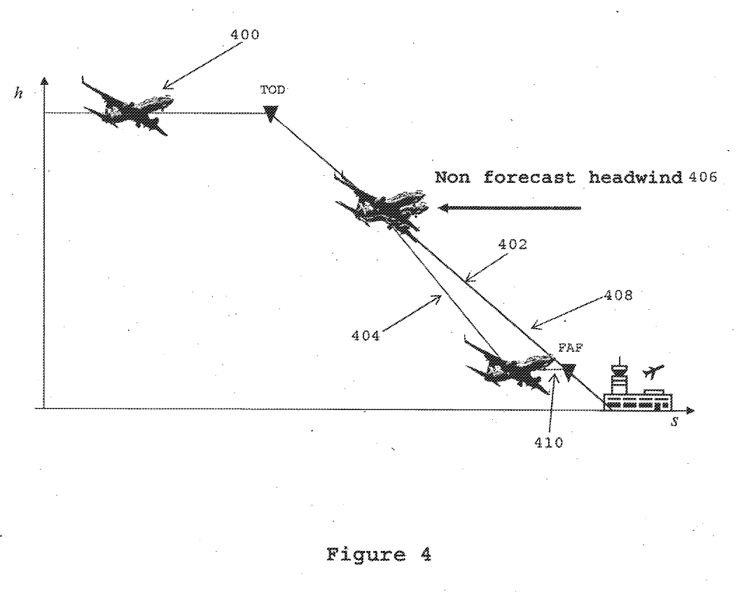

As illustrated in FIG. 4, after commencing descent, if the aircraft 400 encounters unforeseeable circumstances such as unexpected headwind 406 and is to deviate 404 from the planned descent trajectory 402, the FMS can apply two types of control logic to counteract; it can either attempt to adhere to the planned target speeds or to the planned geometric descent path. This is known as speed managed mode (aerodynamic descent) and path managed mode (path descent) respectively.

When in speed managed mode, the FMS applies elevator control to maintain the target airspeed at idle thrust (speed-on-elevator). When the nose of the aircraft is pointed downwards (by control of the elevator), the aircraft is sped up, whilst the nose of the aircraft is pointed upwards, the aircraft is slowed down. In this way, the altitude of the aircraft is the degree of freedom to balance the error in predicted total energy (potential energy). However, when in path managed mode, the FMS applies in principle elevator control in order to maintain the path at idle thrust (path-on-elevator). This results in that the airspeed is the degree of freedom to balance the error in predicted total energy (kinetic energy) 408.

In speed managed mode, an error in predicted total energy will be balanced by altitude, i.e. potential energy. This means that in order to maintain the target speed at idle thrust, the aircraft deviates from the planned path. If for example the aircraft encounters more headwind than what was predicted by the forecast information used by the FMS in the descent planning phase, the planned descent path is too shallow to be flown at the target speed while maintaining idle thrust. Elevator control is applied and the aircraft is pitched down to maintain the target speed. Because of the pitch down, the geometric path angle is increased and hence the aircraft enters a ‘below path’ situation. This leads to a prediction error which will therefore be mainly in the altitude component of the trajectory. Prior to reaching the FAF a (near) level segment is required to bring the aircraft back on profile 410. As a result of this flight path, the estimate arrival times are subsequently influenced as the altitude error, an excess or shortage in potential energy needs to be balanced with kinetic energy which influences the speed of the aircraft and the time required to reach its destination.

In path managed mode, an error in predicted total energy will be balanced by speed variations, i.e. kinetic energy. If for example the aircraft encounters more headwind than what was predicted by the forecast model used by the FMS in planning the descent path, the aircraft cannot be held at the target speed while maintaining idle thrust due to the error in forecast headwind. In this instance, elevator control is applied and the aircraft is pitched up to maintain the path and prevent a ‘below path’ situation causing the airspeed to decrease. If required, thrust may be added through throttle control when the airspeed deviates too far below target. Or similarly, speed brakes deflection might be required when the speed deviates too far above target. In this situation, the prediction error will therefore be mainly in the time component of the trajectory as the difference in total energy is balanced by kinetic energy affecting speed and hence time.

As discussed above, embodiments of FMS found in some advanced aircraft may be able to plan and execute an automated descent. The FMS planned trajectory, or reference trajectory, will not be perfectly accurate. For example, the data provided to the FMS on environmental conditions may not reflect the true conditions accurately. There will therefore be deviations from the reference trajectory. Additional control input is therefore necessary to ensure the aircraft stays within particular constraints, which may be required by air traffic control or others. For example, the aircraft may be constrained within a path within three dimensional space, but not constrained as to speed and therefore time. Alternatively, the aircraft may be constrained with the speed, but this may lead to variations in altitude due to deviations from the reference trajectory when at idle thrust.

The applicants have appreciated that a planned or reference trajectory by the FMS is limited in its accuracy and if used slavishly for planning control of airspace leads to errors. For the most part, the actual trajectory will deviate from the planned trajectory, leading to differences in position and/or time of the aircraft from those planned. This leads to reduced predictability to air traffic control resulting in subsequent inefficiencies to aircraft operation.

In an embodiment of the present invention, further processing is applied to a received reference trajectory for an aircraft, in order to arrive at a predicted trajectory for the aircraft which, in embodiments, is more accurate than the reference trajectory and closer to the trajectory that will actually be flown by the aircraft. This improves ATC efficiency and performance.

In this embodiment, the process determines deviations from the reference trajectory to provide the predicted trajectory.

In embodiments, more accurate models may be used to process the reference trajectory e.g. more accurate environmental models, where the model may have more accurate environmental input, and/or more accurate aircraft performance models (APM). These environment models may be implemented by a weather module which generates an environmental profile appropriate for the aircraft in consideration. The accurate environmental input may consist of a series of localised environmental measurements in the area of the descent.

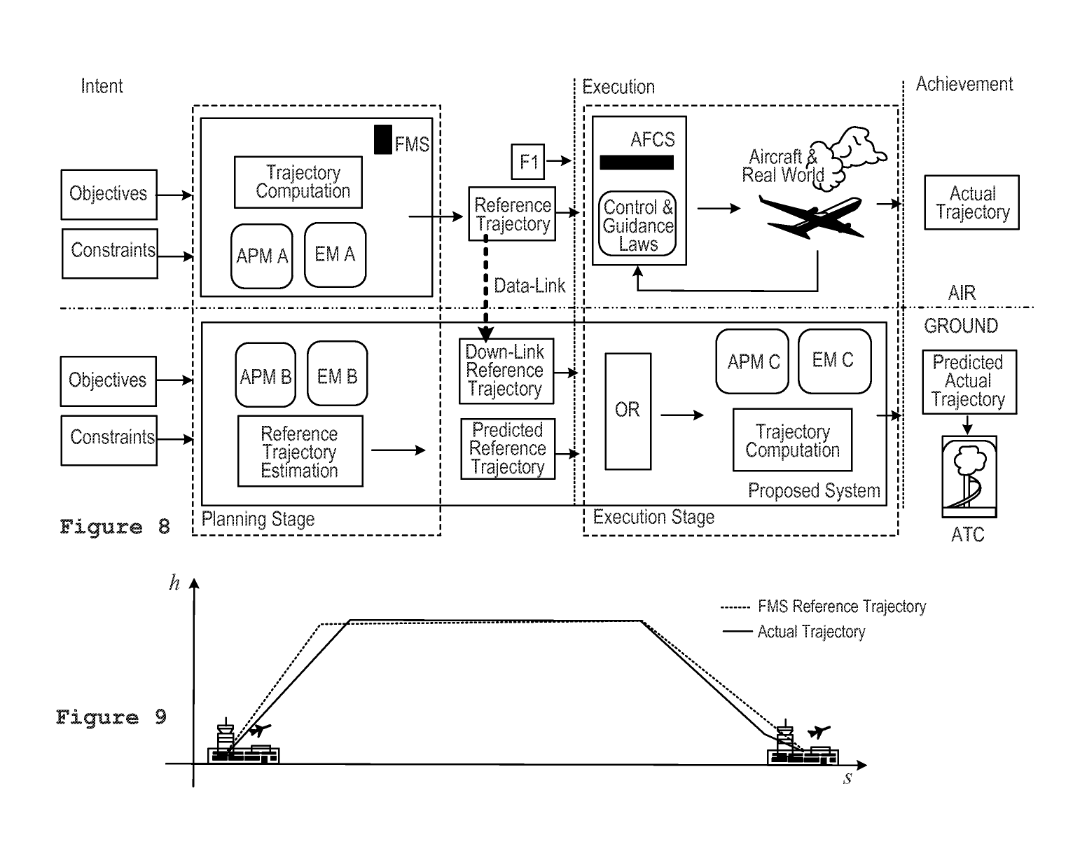

A general process in accordance with an embodiment of the present invention will now be described with reference to FIGS. 8 and 9.

Upon entering the objectives and constraints for a flight in the Flight Management System (FMS) of an aircraft, the FMS computes the optimised trajectory meeting these objectives and constraints using an Environmental Model A (EM A) and an Aircraft Performance Model A (APM A), the latter is a model of the aircraft's aerodynamic and propulsive behaviour. This planned or reference trajectory is subsequently used to provide as reference to the Automatic Flight Control System (AFCS) to control to.

Upon execution, encountered conditions are likely to be different to those described in the models A. Therefore the AFCS needs to apply active control to direct the aircraft to one or more dimensions of the reference trajectory. Which parameters of the reference trajectory, and how many, the AFCS controls to is dependent on the active guidance laws, combined referred to as the guidance strategy. For example, during climb a common guidance strategy is to control to the lateral path and the speed of the reference trajectory, but not to the altitude profile. This means that depending on the accuracy of the models A, the aircraft might arrive at Top of Climb (TOC) at a different position and earlier or later than indicated by the reference trajectory. Another example, during descent, and with the automation in control, the aircraft will commence descent at the Top of Descent (TOD) indicated by the reference trajectory. However after commencing descent the automation has the choice to control to either the altitude profile of the reference trajectory or the planned speed schedule of the reference trajectory (discussed in a previous paragraph). With inaccuracies in the models A and in the case of controlling to altitude, the aircraft will either slow down or speed up. With inaccuracies in the models A and in the case of controlling to speed, the aircraft will depart the altitude profile of the reference trajectory and be either above path or below path. An example of the deviations from the reference trajectory in the vertical plane is given in FIG. 9. The assumed guidance strategy is speed managed climb/descent.

In a more general sense, the dimensions of the reference trajectory related to the parameters the AFCS is controlling to will be very accurate. These dimensions will be referred to as controlled. For example in a path managed descent, the lateral path and altitude are controlled. The only difference between the reference trajectory and the actual flown trajectory in these dimensions will be the flight technical error, i.e. how well the AFCS is able to follow the reference trajectory. In case of the dimensions of the reference trajectory related to the uncontrolled parameters, these dimensions will not be as accurate. These dimensions will be referred to as free. For example in a path managed descent, speed is not (actively) controlled and hence time is free. While the first three dimensions of the reference trajectory are accurate, the estimated times of arrival of the reference trajectory won't be. A similar description can be made for all the different guidance strategies, be it with different controlled and free dimensions.

An embodiment of the present invention implements a two stage Trajectory Prediction model. The Trajectory Predictor (TP) obtains the reference trajectory from the aircraft, and simulates the execution of this reference trajectory with knowledge of the active guidance strategy with use of models C of similar or superior accuracy than models A. Because of superior accuracy of at least one of the models C, part of the aircraft's deviation (in the open dimensions) of the reference trajectory can be predicted. How much of these deviations can be predicted is mainly dependent on the improved accuracy of the models C over the models A. In case the reference trajectory computed by the FMS cannot be obtained (for example there is no data-link option), a prediction of the FMS reference trajectory can be made by the proposed system. Ideally this computation process and the models B should be fully synchronised with the computation process within the FMS and the models A.

The key to the two-stage TP is that when the reference trajectory, computed using process and support models A (or B), is executed using process and support models C, deviations will result in one or more free dimensions from the reference trajectory depending on the assumed control and guidance laws. These computed deviations are a prediction of the aircraft's actual deviations from the reference trajectory when executing this reference trajectory in the real world. Hence the execution stage of the two-stage TP results a prediction of the actual trajectory of the aircraft. Provided that (1) the support models and process in the execution stage are of higher accuracy and fidelity than those in the planning stage and hence, if synchronised, those of the FMS and (2) the correct control and guidance laws are assumed, it is in fact a ground based trajectory system that has the potential to provide the most accurate prediction of the actual trajectory of an aircraft and not the aircraft itself. The improvement in accuracy is mainly in the free dimensions. Referring to FIG. 8, the FMS computed trajectory is a reference trajectory and hence is placed in the intent stage (it describes what the aircraft wants to achieve); the final computed trajectory by the two-stage TP is a prediction of the actual trajectory and is placed all the way at the right in the achievement stage. The difference between the two computed trajectories is that the trajectory computed by the two-stage includes a prediction of the execution and the effect of the control logic on the actual trajectory.

Model C may be more accurate than model A because it may have access to, for example, more accurate environmental conditions, as the system may be ground based in the vicinity of the environment where the aircraft is operating. Alternatively or additionally, process C may be better a mathematical model than those available at the FMS. The step of reprocessing the reference trajectory in this way, leads to a more accurate prediction of the actual trajectory.

Flying an aircraft can be evaluated from the perspective of energy management. The free dimensions contain some error related to the energy management actions the AFCS needs to apply in order to control to the other dimensions of the reference trajectory. Therefore the reference trajectory could be seen as the realisation of the acquiring (climb) and dissipation (descent) of the total energy possessed by the aircraft. This total energy is a combination of potential and kinetic energy. Therefore, if any inaccuracies exist in computing the reference trajectory (for example inaccurate models A), this reference trajectory will not accurate reflect the total energy possessed by the aircraft at different stages in the flight. It is this error in predicted total energy that subsequently needs to be managed through an appropriate guidance strategy. Effectively, the guidance strategy balances the error in predicted total energy with either potential energy or kinetic energy. When balancing with potential energy, the reference altitude profile will be departed. When balancing with kinetic energy, speed and time will be affected. Note that departing the reference altitude profile will also affect time but indirectly. Energy can also be added through the application of thrust or dissipated through the application of speed brakes. Either way it will be the guidance strategy commanding or instructing these active energy management actions. In summary, the deviations (in free dimensions) from the reference trajectory can be seen as a measure of the error in the total energy as predicted by the FMS when computing the reference trajectory using models A. If models C are of superior accuracy to models A, and if used to simulate or predict the execution of the descent, than the difference between these models will provide a prediction of the deviations of the aircraft from the reference trajectory, and hence provides a prediction of the error in total energy that is to be balanced by the AFCS when executing the trajectory.

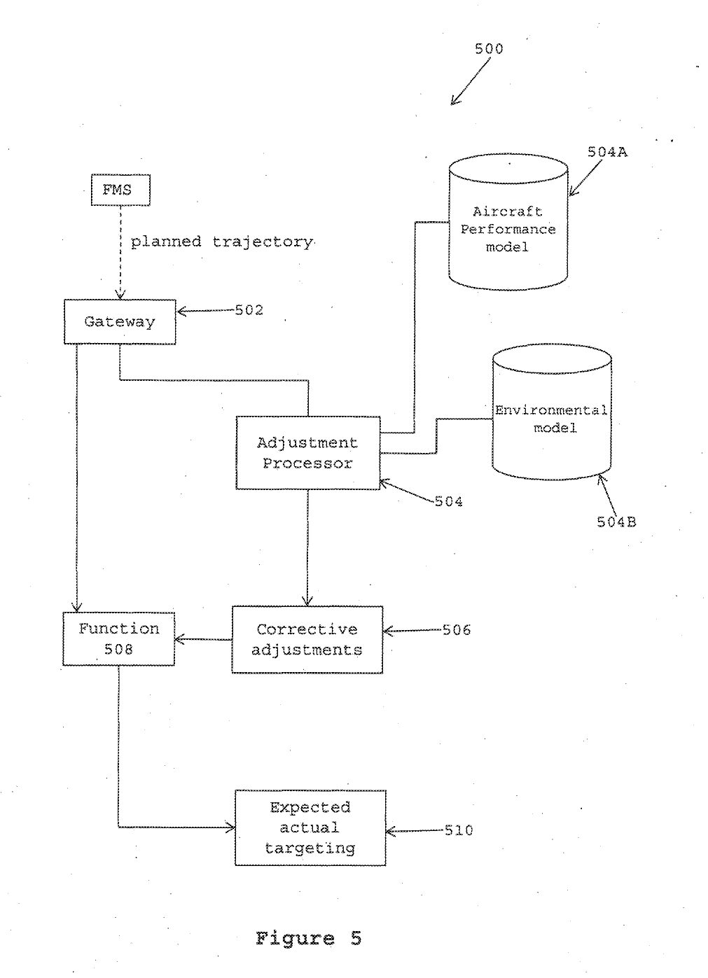

With reference to FIG. 5, there is illustrated a block diagram of a system 500 for predicting an actual trajectory of an aircraft comprising:
a gateway arranged to receive a planned trajectory of an aircraft, wherein the planned trajectory represents a reference trajectory expected to be followed by the aircraft;
an adjustment processor arranged to derive a set of corrective adjustments expected to be executed by the aircraft in following the planned trajectory, wherein the set of corrective adjustments includes at least one control directive arranged to direct the aircraft to follow the planned trajectory; and
a function arranged to process the planned trajectory with the set of corrective adjustments to determine an actual trajectory flown.

The control directive may comprise one or more active guidance laws based on the guidance strategy for the aircraft. For example the control directive may direct the aircraft to follow the three dimensional spatial path of the trajectory and in this case speed is an open dimension.

In this embodiment, the system for predicting an actual trajectory of an aircraft may be a system which is implemented with one or more computers, computing devices, electronic circuits, programmable logic devices or any other electrical, mechanical or electronic devices arranged to provide processing ability. The system may include any combination of hardware and/or software implemented to operate as a gateway, an adjustment processor or a function so as to carry out the necessary steps in predicting an actual trajectory of an aircraft.

Preferably, the system 500 is implemented on a computing device stationed on a ground station having a communication link with aircrafts within the airspace of the ground station although it is also possible that the system 500 is implemented on one or more portable computing devices in various locations. In some embodiments, the system 500 may also be implemented on a computing device on board an aircraft.

As shown in FIG. 5, the system 500 has an aircraft data gateway arranged to communicate with the FMS of an aircraft within the serviced airspace. The system 500 also has an adjustment processor arranged to derive a set of corrective adjustments expected to be executed by the aircraft in following the planned trajectory. The adjustment processor may have access to various models including an Aircraft Performance Model (APM) of the aircraft concerned or real time weather models of the environment to which the system 500 is servicing. Finally, as shown in the embodiment of FIG. 5, the system 500 also has function to combine a reference trajectory received from a concerned aircraft with the corrective adjustments derived by the adjustment processor to predict an actual trajectory flown by the aircraft concerned.

The aircraft data gateway 502 may include a data link or other forms of communications link which is arranged to communicate with an FMS of an aircraft. Once a communication link is established, the FMS of an aircraft may be able to transmit aircraft data to the gateway for processing by the system 500. This aircraft data may, for example, include a planned descent trajectory for the aircraft to descend to its destination airport.

Once the planned descent trajectory is transmitted from the FMS of the aircraft to the system 500, the adjustment processor 504 may then proceed to process the planned descent trajectory to identify whether there will be any deviations for the aircraft from the planned descent trajectory once the aircraft executes this planned descent trajectory. In one example, the adjustment processor 504 applies an Aircraft Performance Model 504A and a weather model 504B to the planned descent trajectory and in this process, simulates the aircraft in executing the planned descent trajectory. By simulating the behaviour of the aircraft while executing the planned descent trajectory using a weather model 504B, adverse weather effects which were not previously factored into the calculation of the planned descent trajectory by the FMS onboard the aircraft may then cause the adjustment processor to simulate a deviation from the planned descent trajectory of the aircraft (the weather model 504B likely being more accurate). Once the deviations are simulated, corrective adjustments 506 in the form of control inputs may also be simulated by the adjustment processor 504 to return the aircraft to the planned descent trajectory.

Once the simulation is completed by the adjustment processor 504, a list of one or more control adjustments 506 are derived to maintain the aircraft on the planned descent trajectory. This list of one or more control adjustments are then further processed by a function 508 arranged to combine the adjustments together with the previously received planned descent trajectory. The calculation process is integrated and various steps may be performed in parallel by the system. As each corrective adjustment alters the speed, position and estimated time of arrival of the aircraft, when combined with the planned descent trajectory received from the FMS, a predicted actual trajectory 510 of the aircraft is therefore generated. This trajectory is therefore a prediction of the actual trajectory expected to be flown by the aircraft in executing the FMS's planned descent trajectory.

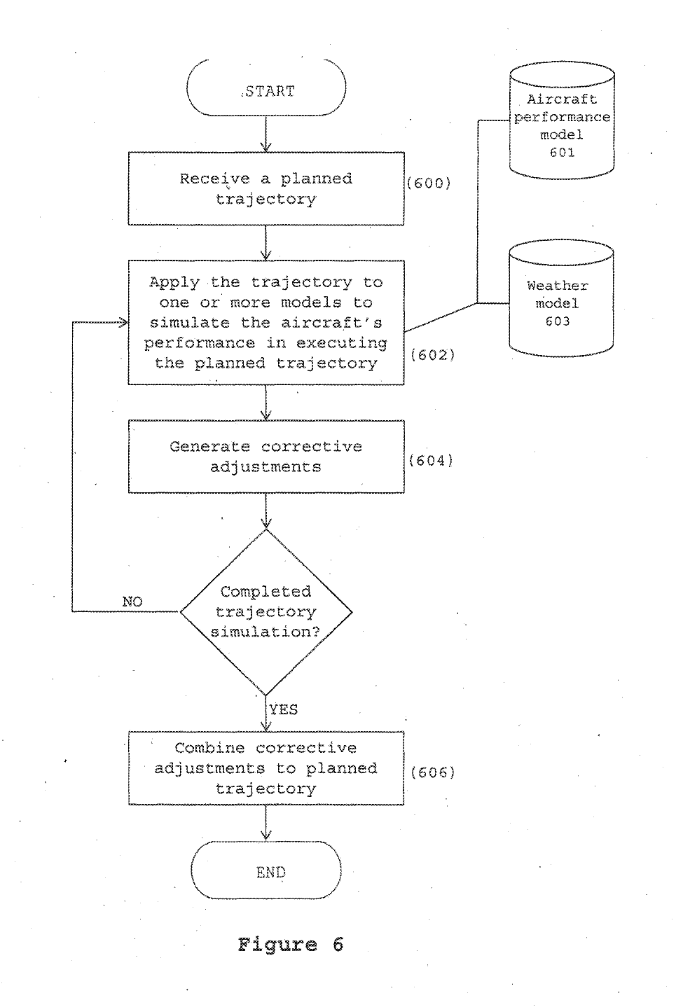

With reference to FIG. 6, there is illustrated a flow chart illustrating the procedures in the operation of the system 500 in predicting a trajectory expected to be actually flown by the aircraft. In this embodiment, once an aircraft is approaching an airport, the pilot may input specific information to the FMS of the aircraft to plan its descent to the desired runway. The FMS may then proceed to produce a planned descent path for the aircraft based on the best information available to the FMS at this time.

Once the planned descent path is generated by the FMS, it is then transmitted to the system 500 through a data link, or partly or in whole through other forms of communications means (600). In case no data link or other form of communication is available to transmit the planned trajectory computed by the FMS, a ground based system arranged to simulate an aircraft flight management system can be used to make a best estimate of the trajectory planned by the FMS. It is subsequently this ground based system estimate of the FMS planned trajectory that is sent to the system 500. The system 500, upon receiving the planned trajectory proceeds to apply this planned descent trajectory to the adjustments processor 504, which in one embodiment acts as a simulator (602). In this embodiment, the adjustments processor 504 is provided with two sources of data, the first being an aircraft performance model 601 which has information relating to the characteristics of the aircraft, including any information relating to the aerodynamics, physics and physical limitations of the aircraft and a second data source being one or more environmental models 603 relevant to the airspace in the near vicinity of the aircraft as the aircraft travels along the planned descent trajectory. These environmental models may include very detailed weather models of the areas surrounding the airport, including air pressure, humidity, temperature, wind speed and direction at any 3 dimensional points around the airport at a particular time. By having this information, the effects of these weather models on the aircraft flying through the airspace around the airport can be simulated.

Once the planned descent trajectory is applied to the adjustments processor 504, the system 500 is then able to determine whether there are any deviations to the path of the aircraft as it executes the planned descent trajectory. The models 601, 602 applied to the simulation step may be more accurate than the models implemented by the FMS to calculate the reference trajectory. For example, the ground based system may have access to more accurate weather data than an airborne FMS. More powerful processing and more accurate algorithms may be available to a ground based system.

At step 602, applying the simulation, using the model 601, 603, will determine any deviations from the reference trajectory. For example, the ground base weather model 603 may be aware of cross winds, head winds and other weather conditions that may affect the aircraft performance to cause it to deviate from the reference trajectory.

Once these deviations to the planned descent trajectory can be ascertained, corrective controls to the aircraft can be predicted in order to keep the aircraft within the parameters of the planned descent trajectory (604). This may include the application of thrust or speed brake (power/drag) or elevator controls (pitch) to the aircraft in order to bring the aircraft to back to the planned trajectory. As the application of these controls may in turn change the performance of the aircraft, these changes to the performance are then reapplied to the simulator until the aircraft is simulated to have completed its descent.

Once the simulation by the adjustments processor 504 is complete, in an embodiment, these control adjustments are then summarized and then combined with the planned (reference) descent trajectory received from the aircraft FMS (606). The result of this is that the system 500 is able to generate a prediction of the actual trajectory flown by the aircraft during the execution of the planned descent. This predicted actual trajectory can then be used by air traffic control to more accurately predict the performance of aircraft within its airspace.

A more accurate prediction of aircraft trajectories, for a plurality of aircraft gives air traffic control a more accurate picture of future positions of aircraft within the controlled airspace. This increases the efficiency of the service provided by air traffic control to individual aircraft.

### An Example of Simulation by the Adjustments Processor.

In one example, the adjustments processor 504 can be arranged to simulate an aircraft's behaviour during the execution of the planned descent trajectory by using a simulator function or routine to simulate the total energy of the aircraft on descent from the Top of Descent (TOD).

In this regard, the predicted total energy of the aircraft on descent implicitly determined in the descent planning process can be expressed by Equation (5) below.

$${\hat{E}}_{DES} = \frac{1}{2} m {V}_{FAF}^{2} + {mgh}_{FAF} + {\int }^{PATH} \hat{T} d s - {\int }^{PATH} \hat{D} d s \qquad ( 5 )$$

Where, T represents Thrust, D represents Drag, FAF is the Final Approach Fix and DES represents the Descent.

An error in this prediction process is reflected by the excess energy E(exc) which is effectively a shortage when negative. This can be measured by the following equation (6) which is simply expressed as the actual energy dissipated during descent less the predicted energy dissipated during the descent according to the planned descent trajectory.

E_{EXC}=(E_{DES})_{ACT}−Ê_{DES} (6)

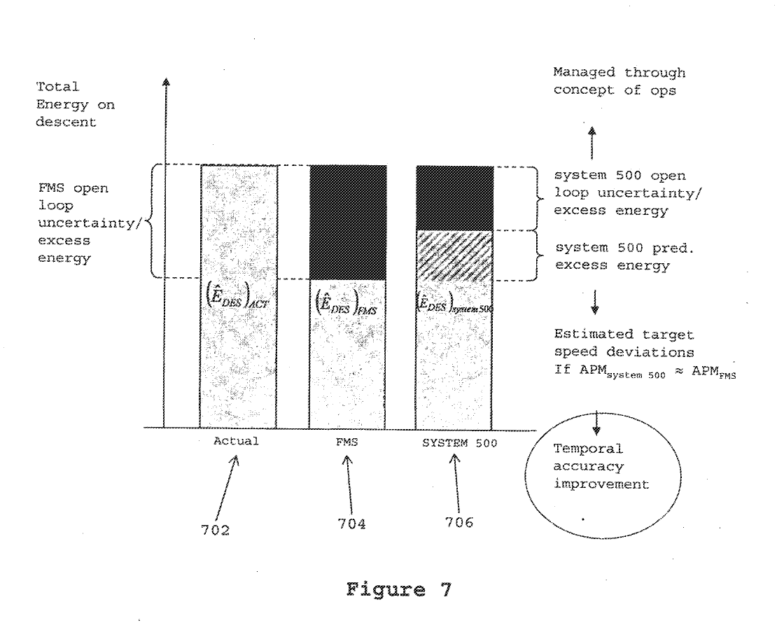

These formulas may be expressed by illustrations of FIG. 7 which shows a bar graph illustrating the difference in the energy values of the aircraft. As shown, the most left column 702 represents the actual total energy for the descent, the middle column 704 represents the implicit FMS predicted total energy for descent, and the most right column 706 represents the implicit predicted total energy for descent by the system 500.

In one example, the FMS prediction of total energy for descent 704 is reflected in the geometry of the descent profile it computed. As is illustrated, a large error exists in certain examples 704A when compared with the actual energy. This is because the FMS prediction will generally not be accurate, as it is based on a model which does not reflect actual conditions accurately. Of course, sometimes the FMS model may be reasonably accurate, depending upon conditions variations and the model. As discussed above, a ground based model applying the prediction 706 may be capable of obtaining a more accurate weather data and may be a more accurate model generally.

The system 500 may be able to predict ahead the changes in airspeed as a result of maintaining the path at idle thrust during a path managed descent, or the vertical deviation from the planned trajectory as a result of maintaining speed at idle thrust during a speed managed descent, i.e. it implicitly predicts the excess energy along the FMS planned descent. Thus the error 706A in the energy 706 predicted by the system 500 is generally lower than that of the FMS 704.

These illustrations of FIG. 7 therefore illustrate at least one advantage of the system 500 in that the total energy or energy dissipation estimated by the system 500 has a smaller error margin compared with the energy dissipation estimated by the FMS. In this way, the predicted trajectory produced by the system 500 is therefore a better indication of the actual trajectory that will be flown by the aircraft than the planned trajectory generated by the FMS. This because the system 500 is able to add to the planned trajectory, the adjustments required to execute this trajectory in the presence of disturbances known to system 500 but not known to the FMS. Therefore the system 500 allows air traffic control to more accurately plan the use of valuable airspace in the areas under control. Accurate planning with precise arrival times will permit efficient air traffic control and aircraft operations.

In one example embodiment, for the system 500 to accurately model the energy during the path managed descent of an aircraft, the excess energy is balanced by changes in kinetic energy, which is represented by this equation.

$${E}_{EXC} = \frac{1}{2} m ( {V}_{ACT}^{2} - {V}_{TARGET}^{2} ) \qquad ( 7 )$$

As can be observed in equation (7), accurate knowledge of the aircraft's mass may be necessary for determination of the speed variations resulting from this excess energy. Whilst the aircraft's mass may be available in some instances, it may not always be provided by the aircraft or operators of the aircraft. In these circumstances, the system 500 may infer an aircraft's mass from the aircraft data received from the FMS of the aircraft which in turn, the inferred mass may then be used as initial condition to the prediction process. This may be referred to as initial condition synchronisation.

It is understood that the system 500 may have access to better environmental models than the FMS; however the aircraft performance model held by the FMS may be more accurate than that of the system 500. This is because the FMS has access to proprietary aircraft performance information not available to the system 500.

In one embodiment, the system 500 is arranged to infer the mass and descent target speed of the aircraft as used by the FMS to calculate the reference trajectory. The input variables to the FMS reference trajectory calculation process are referred to as Trajectory Related Input Variables (TRIV). This information needs to be inferred as current FMS are not capable of (automatically) transmitting this information to air traffic control.

In an embodiment, the mass inferred by the system 500 can then also act as a calibration between the aircraft performance models of the system 500 and the FMS—the aircraft performance models A and C in the illustration of FIG. 8—to improve the aircraft performance model of the system 500.

There are a number of different methods which can be used to infer the mass and descent target speed used by the FMS to generate the reference trajectory. One method for the ground system is to consider the Intermediate Projected Intent (IPI) of the aircraft which consists of up to ten trajectory change points ahead of the aircraft along its intended trajectory, and infer mass and target speed. In one example, a trajectory change point can be an altitude change, a lateral change and/or a speed change of the aircraft whilst travelling through the trajectory. The trajectory change points provided in the IPI provide a representation of the FMS reference or planned trajectory. Note that this embodiment is specific to FANS IPI. To realise improved utilisation of non-radar airspace required by increasing air traffic the Future Air Navigation System (FANS) concept was introduced in the early 1990s. The FANS concept involved improvement on the fields of communication, navigation and surveillance.

To infer Trajectory Related Input Variables used by the FMS to compute the reference trajectory, the system 500 searches for different segment types from the IPI. These segments include:
1. Idle Descent (ID) segments. These are the segments flown at idle thrust while maintaining the target speed schedule. Above crossover altitude the target speed is Mach and below crossover the target speed is Calibrated Airspeed (CAS).
2. Slope Deceleration (SD) segments. These are segments flown at idle thrust but shallower than a normal idle descent segment. The FMS builds these segments to slow the aircraft down from an initial target speed to a new target speed.
3. Level Deceleration (LD) segments. Idem to slope deceleration segments, however these segments are flown at level altitude.
4. Level (L) segments. Level segments flown at the target speed and appropriate thrust to maintain altitude and target speed.
5. Non-idle Descent (ND) segments. These segments are generally the result of (altitude) constraints present that do not allow a true idle descent segment. Non-idle descent segments are in general shallower than an idle segment and therefore flown at higher than idle-thrust. In case a constraint results in a path steeper than an idle segment, the use of speed brakes will be required. For naming convention, in this embodiment, this segment is also referred to as a non-idle descent segment.

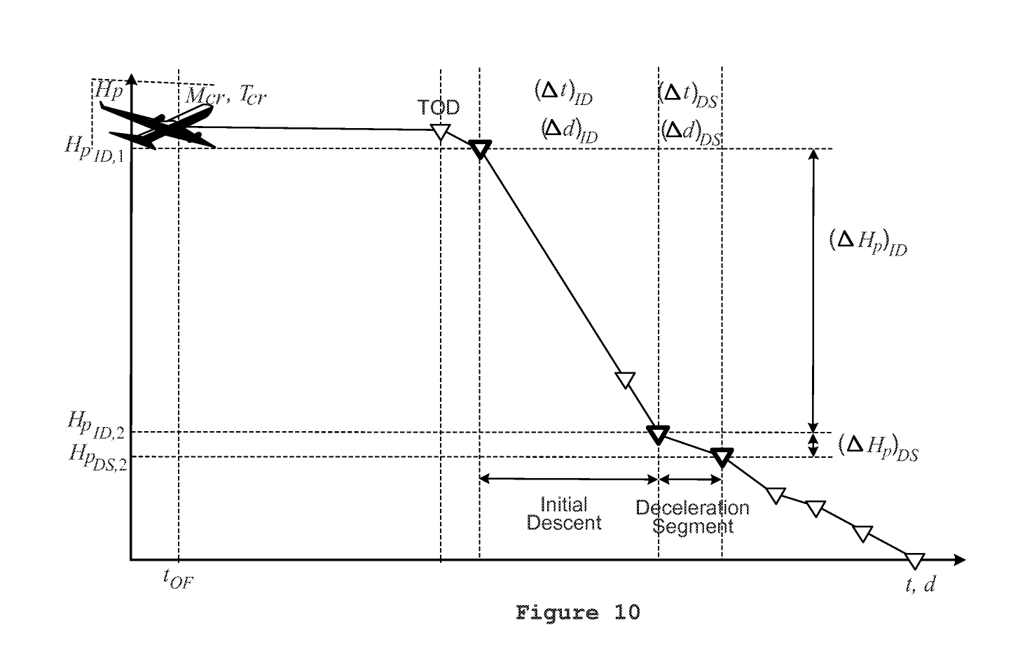

FIG. 10 provides a vertical profile of the IPI received from an arbitrary aircraft prior to commencing descent. In this example, the system 500 identifies:
Two Idle Descent segments collectively referred as the Initial Descent segment. The initial descent starts from TOD, or just after TOD in case of a shallow segment initiating the descent, and ends at the start of the deceleration segment to 250KCAS at 10,000 ft Above Sea Level (ASL), generally around 10,500 ft ASL.
One Slope Deceleration segment. This deceleration segment refers to the deceleration from the selected target descent speed to 250KCAS below 10,000 ft ASL.
One Idle Descent segment within the TMA (TD). As this idle descent segment occurs within the TMA and after the deceleration segment to 250KCAS, the target for this segment is already known: 250KCAS.

In an embodiment, the system 500 is set up to infer the Trajectory Related Input Variables: descent target speed schedule and descent mass. The descent target speed schedule consists of a descent target Mach and descent target CAS.

As mentioned, the target speed schedule is a combination of a Mach and CAS. Most often the target Mach of the descent is equal to the Mach on cruise. This means that the system 500 assumed the target descent Mach to equal the Mach reported in the FANS position report of which the IPI is part. The system 500 checks this Mach number against the Mach number in the flight plan and chooses between either of them based on a configurable threshold. Subsequently, only the descent target CAS becomes a target speed variable for the system 500 to infer.

In a different embodiment, the system 500 can add the target descent Mach to the list of Trajectory Related Input Variables to infer.

Each of the segments identified by the system 500 is used to infer the selected Trajectory Related Input Variables used by the FMS, in an embodiment these are the target descent CAS V_{CAS} and the mass of the aircraft at Top of Descent m_{TOD}.

$${X}_{TRIV} = [ \begin{matrix}{V}_{CAS} \\ {m}_{TOD}\end{matrix} ] \qquad ( 8 )$$

For each of the segments the system 500 composes a trajectory prediction script representing the segment type. For example if the segment type is identified to be an Idle Descent segment, the system 500 composes a script that reflects an idle descent at target speed with altitude and time open. In another example if the segment type is identified to be a Slope Deceleration segment, the system 500 composes a script that reflects a shallow segment at idle thrust with speed open. The variables in these trajectory scripts are the Trajectory Related Input Variables, in an example being descent target CAS and/or mass of the aircraft.

The trajectory scripts generated for the different segments are subsequently integrated by the trajectory prediction engine of the system 500. This calculation is compared with the respective segment in the IPI. The trajectory change points defined by the aircraft IPI (represented in FIG. 10 by the triangles superimposed on the aircraft descent profile) coincide with the start and/or end of a segment. The trajectory script can be integrated, taking the initial conditions from a first trajectory change point and the end trigger conditions from a subsequent trajectory change point. In the example of an Idle Descent segment, the end trigger condition could be set as the time specified at the end trajectory change point of the IPI segment.

This integration can subsequently be performed for a particular set of Trajectory Related Input Variables (such as the target descent CAS and the mass of the aircraft). Upon reaching the trigger condition during the integration, the final value of the free variable can be compared against the value of that variable in the end trajectory change point. If, for example, the free variable is altitude, the final altitude of the prediction can then be compared to the altitude of the end trajectory change point.

The difference in the free variables of the trajectory prediction script between the IPI and the system 500 calculations are referred to as Function values; the process is referred to as a Function,

F_{SEG}_{ᵢ}=F(V_{CAS},m_{TOD})∀i=1,2, . . . N_{segments}̂SEG={ID,SD,LD,L,ND} (9)

The Function values dependent on the Trajectory Related Input Variables. The system 500 determines a Function for each relevant segment in the IPI using the appropriate trajectory script, trigger condition and free variable for that segment. The result is a system of equations that requires to be solved in the Trajectory Related Input Variables as will be explained.

In addition to the Function values, the system 500 determines the first and second derivatives of the Functions in the Trajectory Related Input Variables. As the Functions previously described do not possess a simple closed form expression but rather consist of algorithms, the derivatives are numerically determined through

$$\begin{matrix} \frac{\partial F}{\partial x} ( x , y ) \approx \frac{F ( x + Δ x , y ) - F ( x - Δ x , y )}{2 Δ x} ∀ \{ x , y \} ∈ {X}_{TRIV} & ( 10 ) \\ \frac{\partial F}{\partial y} ( x , y ) \approx \frac{F ( x , y + Δ y ) - F ( x , y - Δ y )}{2 Δ y} ∀ \{ x , y \} ∈ {X}_{TRIV} & ( 11 ) \\ \frac{{\partial }^{2} F}{\partial {x}^{2}} ( x , y ) \approx \frac{F ( x + Δ x , y ) - 2 F ( x , y ) + F ( x - Δ x , y )}{Δ {x}^{2}} ∀ \{ x , y \} ∈ {X}_{TRIV} & ( 12 ) \\ \frac{{\partial }^{2} F}{\partial {y}^{2}} ( x , y ) \approx \frac{F ( x , y + Δ y ) - 2 F ( x , y ) + F ( x , y - Δ y )}{Δ {y}^{2}} ∀ \{ x , y \} ∈ {X}_{TRIV} & ( 13 ) \\ \frac{{\partial }^{2} F}{\partial xy} ( x , y ) \approx \frac{\begin{matrix}F ( x + Δ x , y + Δ y ) - F ( x + Δ x , y - Δ y ) - \\ F ( x - Δ x , y + Δ y ) + F ( x - Δ x , y - Δ y )\end{matrix}}{4 Δ x Δ y} ∀ \{ x , y \} ∈ {X}_{TRIV} & ( 14 )\end{matrix}$$

These numerical derivatives represent the case of two Trajectory Related Input Variables—in an example target descent CAS and aircraft mass—but can be easily be generalised for N Trajectory Related Input Variables.

Note that in cases of segments where one of the Trajectory Related Input Variables does not appear, some of these derivatives are zero by definition. In an example, an Idle Descent segment performed in the TMA (TD) after the deceleration to 250KCAS is not dependent on the target descent CAS to be inferred.

With use of these numerically obtained derivatives the segment type Function can be analytically approximated by a Taylor series expansion around an initial chosen target descent speed and aircraft mass: V_{CAS}_{₀} and m_{TOD}_{₀} respectively.

$${F}_{{SEG}_{i}} \approx {F}_{{SEG}_{i 0}} + {( \frac{\partial {F}_{{SEG}_{i}}}{\partial {V}_{CAS }} )}_{0} ( {V}_{CAS} - {V}_{{CAS}_{0}} ) + {( \frac{\partial {F}_{{SEG}_{i}}}{\partial {m}_{TOD}} )}_{0} ( {m}_{TOD} - {m}_{TOD 0} ) + \frac{1}{2} {( \frac{{\partial }^{2} {F}_{{SEG}_{i}}}{\partial {V}_{CAS}^{2}} )}_{0} {( {V}_{CAS} - {V}_{{CAS}_{0}} )}^{2} + \frac{1}{2} {( \frac{{\partial }^{2} {F}_{{SEG}_{i}}}{\partial {m}_{TOD}^{2}} )}_{0} {( {m}_{TOD} - {m}_{{TOD}_{0}} )}^{2} + {( \frac{{\partial }^{2} {F}_{{SEG}_{i}}}{\partial {V}_{CAS} \partial {m}_{TOD}} )}_{0} ( {V}_{CAS} - {V}_{{CAS}_{0}} ) ( {m}_{TOD} - {m}_{{TOD}_{0}} ) \\ \begin{matrix}∀ i = 1 , 2 , … {N}_{segments} ⋀ SEG \\ = \{ ID , SD , LD , L , ND \}\end{matrix} \qquad ( 15 )$$

The subscript zero means the value is evaluated at the initial chosen values for the Trajectory Related Input Variables. For readability define

$$Δ {X}_{TRIV} = [ \begin{matrix}( {V}_{CAS} - {V}_{CAS 0} ) \\ ( {m}_{TOD} - {m}_{TOD 0} )\end{matrix} ] \qquad ( 16 )$$

and thus

$${F}_{{SEG}_{i}} \approx {F}_{{SEG}_{{i}_{0 }}} + {( \frac{\partial {F}_{{SEG}_{i}}}{\partial {V}_{CAS}} )}_{0} Δ {X}_{TRIV} [ 1 ] + {( \frac{\partial {F}_{{SEG}_{i}}}{\partial {m}_{TOD}} )}_{0} Δ {X}_{TRIV} [ 2 ] + \frac{1}{2} {( \frac{{\partial }^{2} {F}_{{SEG}_{i}}}{\partial {V}_{CAS}^{2}} )}_{0} Δ {{X}_{TRIV} [ 1 ]}^{2 } + \frac{1}{2} {( \frac{{\partial }^{2} {F}_{{SEG}_{i}}}{\partial {m}_{TOD}^{2}} )}_{0} Δ {{X}_{TRIV} [ 2 ]}^{2} + {( \frac{{\partial }^{2} {F}_{{SEG}_{i}}}{\partial {V}_{CAS}^{ } \partial {m}_{TOD}} )}_{0} Δ {X}_{TRIV} [ 1 ] Δ {X}_{TRIV} [ 2 ] \\ \begin{matrix} ∀ i = 1 , 2 , … {N}_{segments} ⋀ SEG \\ = \{ ID , SD , LD , L , ND \}\end{matrix} \qquad ( 17 )$$

As the Functions represent the differences between IPI segments and the segments predicted by the system 500, ideally all Function values should be zero,

F_{SEG}_{ᵢ}=0 ∀i=1,2, . . . N_{segments}̂SEG={ID,SD,LD,L,ND} (18)

Whenever N_{segments} is larger than the number of Trajectory Related Input Variables to be inferred, equations (17) and (18) represent an over-determined system of non-linear equations that requires to be solved in the Trajectory Related Input Variables.

To solve the system of equations the principle of non-linear least squares is applied. The basis of this principle is to approximate the problem with a linear problem and then refine the parameters through successive iteration,

$${F}_{{SEG}_{i}} \approx {F}_{{SEG}_{i}} ( Δ {X}_{{TRIV}_{k}} ) + {\sum }_{j = 1}^{{N}_{TRIV}} {( \frac{\partial {F}_{{SEG}_{i}}}{\partial Δ {X}_{TRIV} [ j ]} )}_{k} ( Δ {X}_{TRIV} [ j ] - Δ {X}_{{TRIX}_{k}} [ j ] ) \qquad ( 19 )$$

where the subscript k indicates the iteration step.

As a first step the Jacobian matrix of the Functions (17) is determined in the variable vector (16) evaluated at the values of ΔX_{TRIV} at the current integration step,

$${J}_{k} = [ \begin{matrix}\frac{\partial {F}_{{SEG}_{1}}}{\partial Δ {X}_{TRIV} [ 1 ]} ( Δ {X}_{{TRIV}_{k}} ) & … & \frac{\partial {F}_{{SEG}_{1}}}{\partial Δ {X}_{TRIV} [ {N}_{TRIV} ]} ( Δ {X}_{{TRIV}_{k}} ) \\ ⋮ & ⋱ & ⋮ \\ \frac{\partial {F}_{{SEG}_{{N}_{segments}}}}{\partial Δ {X}_{TRIV} [ 1 ]} ( Δ {X}_{{TRIV}_{k}} ) & … & \frac{\partial {F}_{{SEG}_{{N}_{segments}}}}{\partial Δ {X}_{TRIV} [ {N}_{TRIV} ]} ( Δ {X}_{{TRIV}_{k}} )\end{matrix} ] \qquad ( 20 )$$

The next step is to determine the vector with differences from the desired 0 value evaluated at the values of ΔX_{TRIV} at the current integration step,

$$Δ {y}_{k} = [ \begin{matrix}0 - {F}_{{SEG}_{1}} ( Δ {X}_{{TRIV}_{k}} ) \\ 0 - {F}_{{SEG}_{{N}_{segments}}} ( Δ {X}_{{TRIV}_{k}} )\end{matrix} ] \qquad ( 21 )$$

The updated values for ΔX_{TRIV} are subsequently determined by

ΔX_{TRIV}_{ₖ₊₁}=ΔX_{TRIV}_{ₖ}+(Jₖ^{T}Jₖ)⁻¹Jₖ^{T}Δyₖ (22)

The iteration is stopped whenever the value of ΔX_{TRIV} has converged satisfactory. Finally, the values of the Trajectory Related Input Variables are determined as

X_{TRIV}=X_{TRIV}_{₀}+ΔX_{TRIV} (23)

In an embodiment the Trajectory Related Input Variables are the target descent CAS and aircraft mass,

$${X}_{TRIV} = [ \begin{matrix}{V}_{CAS} \\ {m}_{TOD}\end{matrix} ] \qquad ( 24 )$$

Whenever the calculated solution differs more than a specified threshold from the initial conditions, the entire above process including the Function definitions through Taylor Series expansion is repeated for appropriately adjusted initial conditions. Similarly, the initial conditions are appropriately adjusted whenever the resulting solution is not found to be realistic. In an example, the inferred mass could be higher than maximum allowed landing weight.

The remaining cruise flight time to TOD is used to build the initial condition for the aircraft's mass to be used in the prediction process of the system 500,

$${m}_{0} = {m}_{TOD} - {\int }_{t = {t}_{0}}^{{t}_{TOD}} FF ( t ) d t \qquad ( 25 )$$

where FF denotes fuel flow.

As the person skilled in the art may appreciate, the use of energy as a modelling or simulation method of the aircraft executing a planned descent trajectory is only one example method to simulate the aircraft's behaviour during the execution of the planned descent trajectory. Other variables which describe another aspect of the aerodynamics of the aircraft may also be used depending on the information which may be provided to the system 500. In some circumstances where the system 500 is able to obtain additional information from the FMS due to a superior communication link, alternative variables may be used to model or simulate the aircrafts execution of the planned descent trajectory.

In another alternative embodiment, the system 500 may not receive the planned descent trajectory from the FMS of an aircraft. In some embodiments, a planned descent trajectory can be received from a FMS simulator which can be placed on the ground or even within the system 500 itself to simulate the actions of an aircraft's FMS in planning a descent trajectory.

In another embodiment, the system 500 may also be arranged to operate with any vehicle other than conventional fixed-wing aircraft, including but not limited to spacecraft, motor vehicles, rotary wing aircrafts and marine vessels. In these other vehicles, autopilots or control systems may operate as the FMS in the embodiments described above, or alternatively, the autopilots or control system may be simulated for the system 500.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method of predicting an actual trajectory of an aircraft, comprising the steps of:
receiving a reference trajectory planned by a flight management system associated with the aircraft,
applying a process to predict corrective adjustments that the aircraft flight management system is expected to make to follow the reference trajectory in one or more controlled dimensions, and
predicting an actual trajectory from the predicted corrective adjustments, the actual trajectory differing from the reference trajectory in a free dimension.

2. The method of claim 1 comprising generating an updated time of arrival for the aircraft at a target destination from the actual trajectory predicted for the aircraft.

3. A method in accordance with claim 1, comprising determining deviations in aircraft possessed energy from a possessed energy reference associated with the reference trajectory.

4. A method in accordance with claim 1, comprising deriving a set of corrective adjustments expected to be executed by the aircraft in following the reference trajectory.

5. A method in accordance with claim 4, wherein the set of corrective adjustments includes at least one control directive arranged to direct the aircraft to follow the reference trajectory.

6. A method in accordance with claim 5, wherein predicting the actual trajectory comprises processing the reference trajectory with the set of corrective adjustments.

7. A method in accordance with claim 1, wherein predicting the actual trajectory comprises processing the reference trajectory with a set of corrective adjustments determined by adaptive system learning through modelling average performance of a plurality of preceding aircraft in following respective planned trajectories.

8. A method in accordance with claim 3, comprising modelling aircraft performance using environmental models to derive expected deviations from the reference trajectory by the aircraft.

9. A method in accordance with claim 8 wherein the environmental models are produced using parameters derived from a destination weather station, the parameters including air pressure, air temperature, wind strength and wind direction at a plurality of altitudes within a localised region adjacent to the reference trajectory.

10. A method in accordance with claim 1, comprising determining an expected mass and an expected speed of the aircraft from an aircraft performance model using data from the reference trajectory.

11. A method in accordance with claim 1, comprising the step of inferring the expected mass and expected speed of the aircraft in following the reference trajectory from trajectory data from an aircraft Future Air Navigation Systems (FANS) Intermediate Projected Intent (IPI).

12. A system for predicting an actual trajectory of an aircraft, comprising:
a gateway arranged to receive a reference trajectory of an aircraft;
an adjustment processor arranged to derive a set of corrective adjustments expected to be executed by the aircraft in following the reference trajectory, wherein the set of corrective adjustments includes at least one control directive arranged to direct the aircraft to follow the reference trajectory; and
a function arranged to process the planned trajectory with the set of corrective adjustments to predict an actual trajectory to be flown.

13. A flight prediction method comprising:
a ground based computing system receiving a reference trajectory from an aircraft flight management system, the reference trajectory defining a planned descent path for the aircraft to a target destination,
the ground based computing system generating an environmental profile for the target destination from localised environmental parameters derived from measurements at the target destination,
the ground based computing system predicting deviations of the aircraft from the reference trajectory using the localised environmental profile for the target destination and characteristics of the aircraft, and
the ground based computing system determining a descent plan for the aircraft from the reference trajectory and the predicted deviations of the aircraft from the reference trajectory.

14. The method of claim 13 comprising generating an updated time of arrival for the aircraft at the target destination from the predicted deviations of the aircraft from the reference trajectory.

15. The method of claim 13 comprising predicting corrective adjustments that the aircraft flight management system is expected to make during descent to compensate for the predicted deviations from the reference trajectory.

16. The method of claim 15 comprising determining a corrected decent trajectory for the aircraft by applying the determined corrective adjustments to the reference trajectory received from the aircraft's flight management system.

17. The method of claim 13 comprising receiving localised environmental parameters from a destination weather module, the environmental parameters including air pressure, wind strength and wind direction at the target destination.

18. The method of claim 17 comprising applying the received air pressure, wind strength and wind direction parameters at a plurality of altitudes within a localised region adjacent the destination to construct the environmental profile.

19. The method of claim 13 comprising projecting aircraft intent from the reference trajectory of an aircraft and inferring characteristics of the aircraft from the projected aircraft intent.

20. The method of claim 19 comprising projecting aircraft intent at a plurality of discrete change points defined by the reference trajectory for an aircraft and inferring the mass and speed of the aircraft at each of the change points.
